(19) United States
(12) Patent Application Publication
(10) Pub. No.: US 2026/0019138 A1
(43) Pub. Date: Jan. 15, 2026

(54) Methods And Apparatus For Downlink Reference Signal Transmission In Mobile Communications

(71) Applicant: MediaTek Inc., Hsinchu City (TW)

(72) Inventors: Cheng-Rung Tsai, Hsinchu City (TW); Yi-Ru Chen, Hsinchu City (TW)

(21) Appl. No.: 19/253,968

(22) Filed: Jun. 30, 2025

Related U.S. Application Data
(60) Provisional application No. 63/670,204, filed on Jul. 12, 2024.
(60) Provisional application No. 63/672,780, filed on Jul. 18, 2024.

(51) Int. Cl. H04B 7/06; H04L 5/00

(52) U.S. Cl. CPC H04B 7/06968; H04L 5/0044

(57) ABSTRACT

Various solutions for downlink (DL)-reference signal (RS) transmission with respect to an apparatus are described. An apparatus may receive a DL-RS with at least one first antenna port from a network node. The apparatus may receive a DL channel with a quasi-colocation (QCL) assumption or synchronization according to the DL-RS from the network node. The apparatus may perform a demodulation of the DL channel according to the DL-RS.

### CROSS REFERENCE TO RELATED PATENT APPLICATION(S)

The present disclosure is part of a non-provisional application claiming the priority benefit of U.S. Patent Application No. 63/670,204, filed 12 Jul. 2024, and U.S. Patent Application No. 63/672,780, filed 18 Jul. 2024. The contents of which herein being incorporated by reference in their entirety.

### TECHNICAL FIELD

The present disclosure is generally related to mobile communications and, more particularly, to downlink (DL)-reference signal (DL-RS) transmission with respect to apparatus in mobile communications.

### BACKGROUND

Unless otherwise indicated herein, approaches described in this section are not prior art to the claims listed below and are not admitted as prior art by inclusion in this section.

Wireless communication systems may be widely deployed to provide various telecommunication services such as telephony, video, data, messaging, and broadcasts. Typical wireless communication systems may use multiple-access technologies capable of supporting communication with multiple users by sharing available system resources. Examples of such multiple-access technologies may include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In the conventional communication technologies, the downlink (DL)-reference signal (DL-RS) can be used for different purposes. In an example, the DL-RS may be used for the channel-state-information (CSI) acquisition (ACQ). The user equipment (UE) may measure the DL-RS and determine the channel condition (e.g., rank indicator (RI), precoding matrix indicator (PMI), channel quality indicator (CQI)) according to the DL-RS measurement. Then, the UE may feedback the determined channel condition to the network node. According to the feedback of channel condition from the UE, the network node can optimize various aspects of communication, e.g., the beamforming, the link adaptation, and the resource allocation.

In another example, the DL-RS may be used for the beam management (BM). The UE may measure the DL-RS and determine the beam quality (e.g., reference signal received power (RSRP), signal to interference plus noise ratio (SINR)) according to the DL-RS measurement. In addition, the UE may adjust the UE-side reception (Rx) or transmission (Tx) beams according to the DL-RS measurement. According to the determined beam quality, the UE and the network node can perform the beam selection, the beam reporting, the beam switching, the beam failure detection, or the beam recovery.

In another example, the DL-RS may be used for synchronization or tracking. The UE may measure the DL-RS to synchronize and track the signal to compensate for the Doppler/phase shifts, delays, and frequency/time drifts according to the DL-RS measurement.

In another example, the DL-RS may be used for demodulation. The UE may measure the DL-RS and perform data channel or control channel demodulation according to the DL-RS measurement.

In another example, the DL-RS may be used for mobility. The UE may measure the DL-RS and determine the cell quality according to the DL-RS measurement for handovers and cell reselection.

However, for synchronization and demodulation, the UE needs to receive different DL-RSs from the network node and use different DL-RSs for synchronization and demodulation respectively.

Accordingly, how to use the same DL-RS for both the synchronization and the demodulation in the wireless communication environments becomes an important issue for the newly developed wireless communication network. Therefore, there is a need to provide proper schemes for DL-RS to achieve energy saving and reduce signal overhead.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to downlink (DL)-reference signal (DL-RS) transmission with respect to apparatus and network node in mobile communications. It is believed that the above-described issue would be avoided or otherwise alleviated by implementing one or more of the proposed schemes described herein.

In one aspect, a method may involve an apparatus receiving a DL-RS with at least one first antenna port from a network node. The method may also involve the apparatus receiving a DL channel with a quasi-colocation (QCL) assumption or synchronization according to the DL-RS from the network node. The method may further involve the apparatus performing a demodulation of the DL channel according to the DL-RS.

In another aspect, a method may involve a network node determining a DL-RS. The method may also involve the network node transmitting the DL-RS with at least one first antenna port to a user equipment (UE). The method may further involve the network node transmitting a DL channel with a QCL assumption or synchronization according to the DL-RS to the UE.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), 6th Generation (6G), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario for a single-symbol DL-RS configuration for more than one antenna ports in accordance with implementations of the present disclosure.

FIG. 3 is a diagram depicting an example scenario for a double-symbol DL-RS configuration for more than one antenna ports in accordance with implementations of the present disclosure.

FIG. 4 is a diagram depicting an example scenario for a single-symbol DL-RS for demodulation in accordance with implementations of the present disclosure.

FIG. 5 is a diagram depicting an example scenario for double-symbol DL-RS for demodulation in accordance with implementations of the present disclosure.

FIG. 6 is a diagram depicting an example scenario for a DL-RS for demodulation in more than one symbols in accordance with implementations of the present disclosure.

FIG. 7 is a diagram depicting an example scenario for another DL-RS for demodulation in accordance with implementations of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with another implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to downlink (DL)-reference signal (RS) transmission with respect to user equipment (UE) and network apparatus in mobile communications. According to the present disclosure, a number of possible solutions may be implemented separately or jointly. That is, although these possible solutions may be described below separately, two or more of these possible solutions may be implemented in one combination or another.

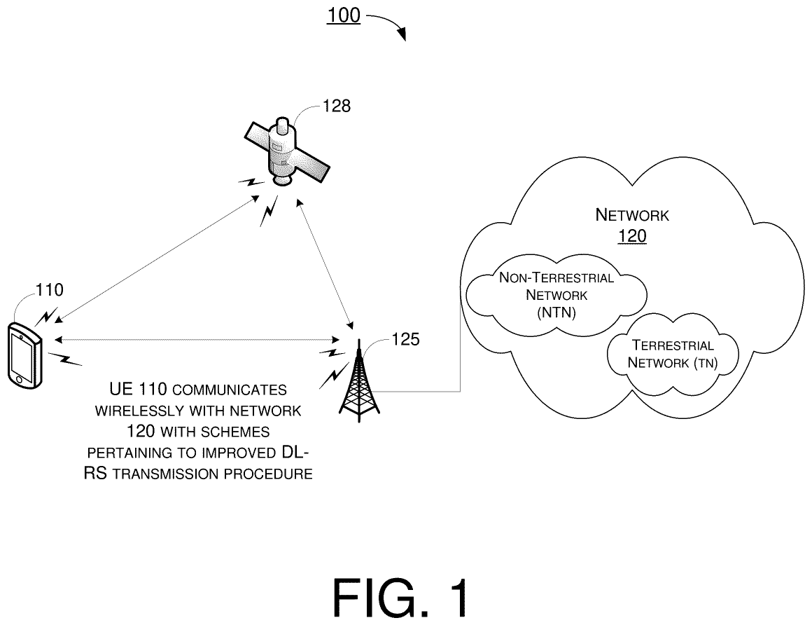

FIG. 1 illustrates an example scenario 100 of a communication environment in which various solutions and schemes in accordance with the present disclosure may be implemented. Scenario 100 involves a UE 110 in wireless communication with a network 120 (e.g., a wireless network including an NTN and a TN) via a terrestrial network node 125 (e.g., an evolved Node-B (eNB), a Next Generation Node-B (gNB), or a transmission/reception point (TRP)) and/or a non-terrestrial network node 128 (e.g., a satellite). For example, the terrestrial network node 125 and/or the non-terrestrial network node 128 may form a non-terrestrial network (NTN) serving cell for wireless communication with the UE 110. In some implementations, the UE 110 may be an IoT device such as an NB-IoT UE or an enhanced machine-type communication (eMTC) UE (e.g., a bandwidth reduced low complexity (BL) UE or a coverage enhancement (CE) UE). In such a communication environment, the UE 110, the network 120, the terrestrial network node 125, and the non-terrestrial network node 128 may implement various schemes pertaining to improving DL-RS transmission procedure in accordance with the present disclosure, as described below. It is noteworthy that, while the various proposed schemes may be individually or separately described below, in actual implementations, some or all of the proposed schemes may be utilized or otherwise implemented jointly. Of course, each of the proposed schemes may be utilized or otherwise implemented individually or separately.

According to the implementations of the present disclosure, an apparatus (e.g., the UE 110) may receive a DL-RS with at least one first antenna port from a network node (e.g., the terrestrial network node 125 or the non-terrestrial network node 128). In addition, the apparatus may receive a DL channel with a quasi-colocation (QCL) assumption or synchronization according to the DL-RS from the network node. The apparatus may perform a demodulation of the DL channel (e.g., physical downlink shared channel (PDSCH) or physical downlink control channel (PDCCH)) according to the DL-RS. That is, the network node may configure the DL-RS for the synchronization/tracking and the demodulation.

According to an implementation of the present disclosure, the apparatus may periodically receive the DL-RS configured from the network node. In an example, the DL-RS may be received at regular intervals or occasions with a certain periodicity.

According to the implementations of the present disclosure, the apparatus may receive the DL-RS through at least one first antenna port.

In example, in an event that the DL-RS is received through more than one first antenna ports, the more than one first antenna ports may be multiplexed in the same resource elements (REs). The first antenna ports may be multiplexed according to the time domain orthogonal cover code (OCC) and/or the frequency domain OCC. The apparatus may spread/schedule the DL-RS with the first antenna ports multiplexed in the same REs according to the time domain OCC and/or the frequency domain OCC.

In another example, in an event that the DL-RS is received through more than one first antenna ports, the more than one first antenna ports may be multiplexed in different REs.

According to the implementations of the present disclosure, the DL-RS may be received in at least one symbol or resource. The DL-RS in each symbol or resource may be received through the same first antenna port or the same first antenna ports. In an implementation, the apparatus may receive all of the symbols or resources of the DL-RS through the same reception (Rx) beam. That is, the network node may transmit all of the symbols or resources of the DL-RS through the same transmission (Tx) beam. In another implementation, the apparatus may receive all of the symbols or resources of the DL-RS according to a same QCL assumption.

According to an implementation of the present disclosure, the DL-RS may comprise an RS resource in one or more symbols. According to another implementation of the present disclosure, the DL-RS may comprise an RS resource set. The RS resource set may comprise one or more RS resources, and each RS resource may be in one symbol.

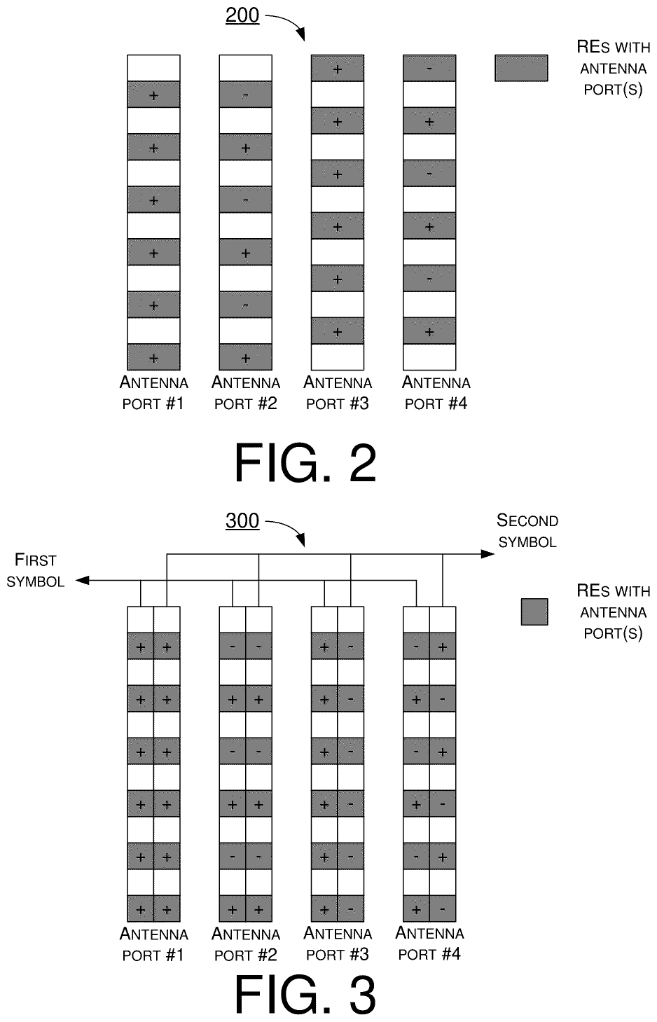

FIG. 2 illustrates an example scenario 200 for a single-symbol DL-RS configuration for more than one antenna ports in accordance with implementations of the present disclosure. Scenario 200 involves a UE and a network node (e.g., a (macro/micro) base station) of a serving cell which may be a part of a wireless network (e.g., an LTE network, a 5G/NR network, an IoT network or a 6G network). Referring to FIG. 2, the DL-RS may be received in one symbol. In addition, the DL-RS may be received through more than one antenna ports (e.g., antenna port #1, antenna port #2, antenna port #3, and antenna port #4). The antenna port #1 and the antenna port #2 may be applied to the same REs with different frequency domain OCCs. For example, the antenna port #1 may be associated with the frequency domain OCC {1, 1, 1, 1, 1, 1} and the antenna port #2 may be associated with the frequency domain OCC {0, 1, 0, 1, 0, 1}, wherein “0” and “1” are expressed by “+” and “−” in FIG. 2. Therefore, the DL-RS may be multiplexed in the same REs applied to the antenna port #1 and the antenna port #2 in the same symbol. The apparatus may spread the DL-RS multiplexed in the same REs applied to the antenna port #1 and the antenna port #2 according to the different frequency domain OCCs. Similarly, the antenna port #3 and the antenna port #4 may be applied to the same REs with different frequency domain OCCs. For example, the antenna port #3 may be associated with the frequency domain OCC {1, 1, 1, 1, 1, 1} and the antenna port #4 may be associated with the frequency domain OCC {0, 1, 0, 1, 0, 1}, wherein “0” and “1” are expressed by “+” and “−” in FIG. 2. Therefore, the DL-RS may be multiplexed in the same REs applied to the antenna port #3 and the antenna port #4 in the same symbol. The apparatus may spread the DL-RS multiplexed in the same REs applied to the antenna port #3 and the antenna port #4 according to the different frequency domain OCCs. In addition, referring to FIG. 2, the antenna port #1 and the antenna port #2, and the antenna port #3 and the antenna port #4 may be applied to different REs. That is, in an event that the DL-RS is received through the antenna port #1, the antenna port #2, the antenna port #3 and the antenna port #4, the DL-RS may be multiplexed in different REs in the same symbol.

FIG. 3 illustrates an example scenario 300 for a double-symbol DL-RS configuration for more than one antenna ports in accordance with implementations of the present disclosure. Scenario 300 involves a UE and a network node (e.g., a (macro/micro) base station) of a serving cell which may be a part of a wireless network (e.g., an LTE network, a 5G/NR network, an IoT network or a 6G network). Referring to FIG. 3, the DL-RS may be received in double symbols (e.g., first symbol and second symbol). In addition, the DL-RS may be received through more than one antenna ports (e.g., antenna port #1, antenna port #2, antenna port #3, and antenna port #4). The antenna port #1, the antenna port #2, the antenna port #3 and the antenna port #4 may be applied to the same REs with different frequency domain OCCs and different time domain OCCs. For example, the antenna port #1 may be associated with the frequency domain OCC {1, 1, 1, 1, 1, 1} for the first symbol and the second symbol. The antenna port #2 may be associated with the frequency domain OCC {0, 1, 0, 1, 0, 1} for the first symbol and the second symbol, wherein “0” and “1” are expressed by “+” and “−” in FIG. 3. The antenna port #3 may be associated with the frequency domain OCC {1, 1, 1, 1, 1, 1} for the first symbol and associated with the frequency domain OCC {0, 0, 0, 0, 0, 0} for the second symbol. The antenna port #4 may be associated with the frequency domain OCC {0, 1, 0, 1, 0, 1} for the first symbol and associated with the frequency domain OCC {1, 0, 1, 0, 1, 0} for the second symbol. Therefore, the DL-RS may be multiplexed in the same REs in the first symbol and the second symbol. The apparatus may spread the DL-RS multiplexed in the same REs applied to the antenna port #1, the antenna port #2, the antenna port #3, and the antenna port #4 according to the different time domain OCCs and different frequency domain OCCs.

According to the implementations of the present disclosure, the DL-RS may be used for the demodulation in an event that the DL-RS of the DL channel overlaps with the DL channel (e.g., the PDSCH or the PDCCH is scheduled on the DL-RS by the network node). That is, in an event that the DL-RS for the synchronization (or tracking) overlaps with the DL channel, the DL-RS for the synchronization (or tracking) can be used as a demodulation reference signal (DMRS) for the demodulation of the DL channel.

According to an implementation of the present disclosure, the DL-RS may overlap with N-th symbol of the PDSCH or the PDCCH, where N may not be larger than a specific/certain/default value. That is, the DL-RS may not overlap with the tail symbol of the DL channel (e.g., the PDSCH or the PDCCH) to avoid worse demodulation performance and too short processing time of the apparatus.

According to an implementation of the present disclosure, the DL channel and the DL-RS (e.g., the DL-RS and the PDSCH or the DL-RS and the PDCCH) may be received in the same time slot.

According to an implementation of the present disclosure, the DL-RS may have a bandwidth the same as or larger than a bandwidth of the DL channel (e.g., the PDSCH or the PDCCH).

According to an implementation of the present disclosure, the DL channel and the DL-RS (e.g., the DL-RS and the PDSCH or the DL-RS and the PDCCH) may be received through a same beam or TRP. For example, the DL-RS and the PDSCH or the DL-RS and the PDCCH may comprise a same QCL assumption. That is, the apparatus may assume that the PDSCH or the PDCCH shares the same QCL assumption as the DL-RS.

According to an implementation of the present disclosure, the DL-RS for the demodulation may have a pattern in the frequency domain. The pattern may comprise an RE mapping or an RE density. The RE mapping of the DL-RS within a symbol may be used for the demodulation. The RE density of the DL-RS within a symbol may be used for the demodulation. For example, the RE density may be larger than a threshold.

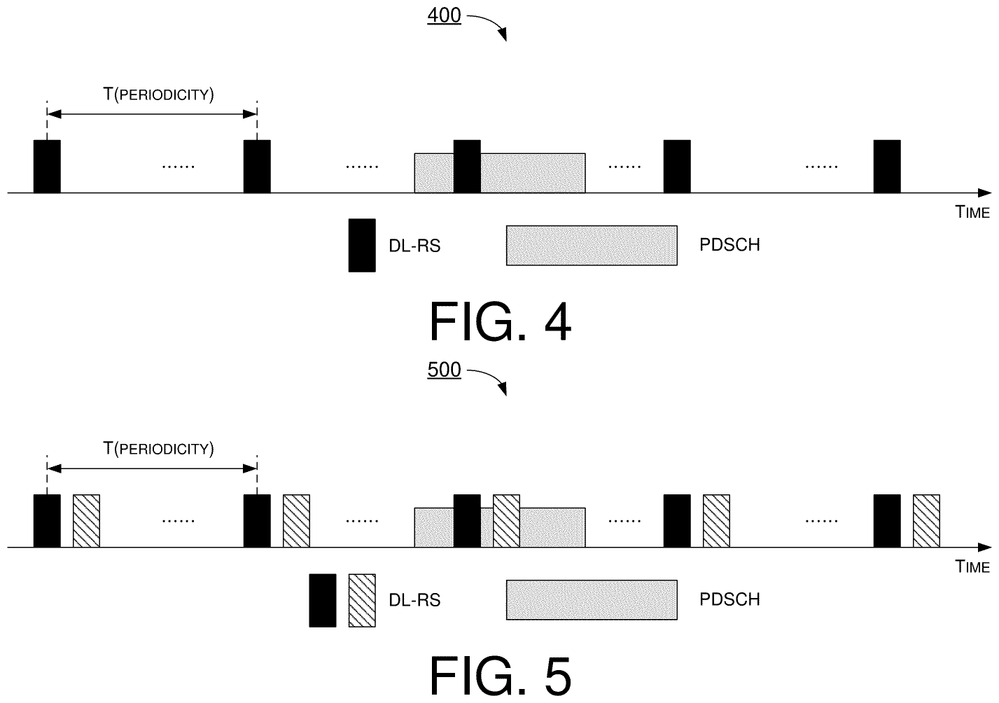

FIG. 4 illustrates an example scenario 400 for a single-symbol DL-RS for demodulation in accordance with implementations of the present disclosure. Scenario 400 involves a UE and a network node (e.g., a (macro/micro) base station) of a serving cell which may be a part of a wireless network (e.g., an LTE network, a 5G/NR network, an IoT network or a 6G network). Referring to FIG. 4, in an event that the single-symbol DL-RS for synchronization (or tracking) overlaps with the PDSCH in the time domain, the single-symbol DL-RS may be used for the demodulation.

FIG. 5 illustrates an example scenario 500 for a double-symbol DL-RS for demodulation in accordance with implementations of the present disclosure. Scenario 500 involves a UE and a network node (e.g., a (macro/micro) base station) of a serving cell which may be a part of a wireless network (e.g., an LTE network, a 5G/NR network, an IoT network or a 6G network). Referring to FIG. 5, in an event that the double-symbol DL-RS for synchronization (or tracking) overlaps with the PDSCH in the time domain, the double-symbol DL-RS may be used for the demodulation.

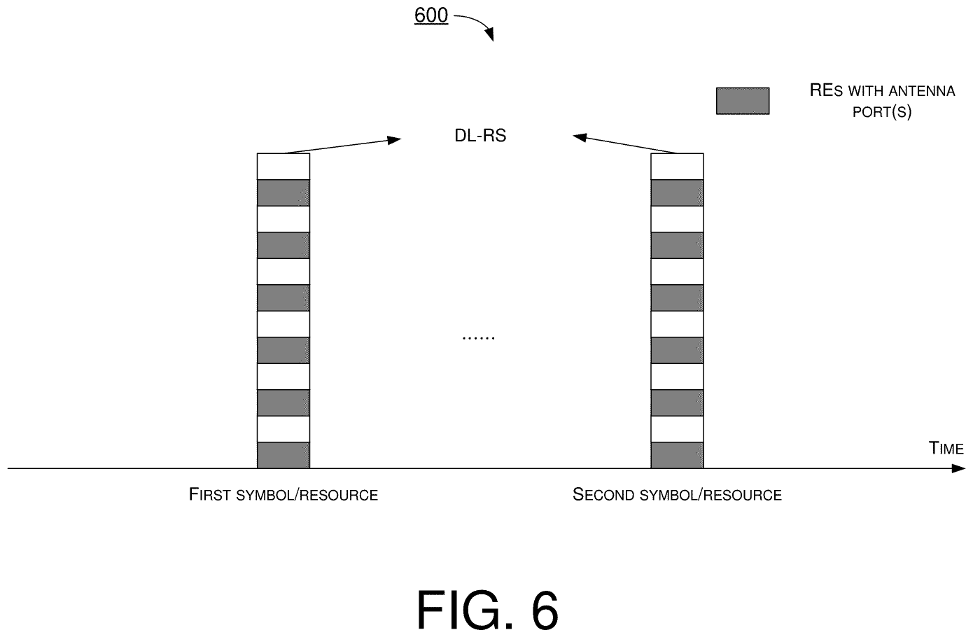

FIG. 6 illustrates an example scenario 600 for a DL-RS for demodulation in more than one symbols in accordance with implementations of the present disclosure. Scenario 600 involves a UE and a network node (e.g., a (macro/micro) base station) of a serving cell which may be a part of a wireless network (e.g., an LTE network, a 5G/NR network, an IoT network or a 6G network). Referring to FIG. 6, in an event that the DL-RS is used for the demodulation of the PDSCH or the PDCCH, and the DL-RS is received through more than one symbols or resources (e.g., the first symbol or resource and the second symbol or resource), the apparatus may assume that the same antenna port or antenna ports may be used in the more than one symbols or resources.

According to the implementations of the present disclosure, in an event that the DL-RS is used for the demodulation of the DL channel (e.g., the PDSCH or the PDCCH), the first antenna port or first antenna ports corresponding to the DL-RS may be used as the antenna port or antenna ports for the demodulation of the DL channel (e.g., the PDSCH or the PDCCH). In another implementation, in an event that the DL-RS is used for the demodulation of the PDSCH or the PDCCH, the apparatus may also use additional antenna ports or antenna ports, in addition to the first antenna port or first antenna ports corresponding to the DL-RS, as the antenna port or antenna ports for the demodulation of the DL channel (e.g., the PDSCH or the PDCCH). The configuration for the additional antenna may be configured by the network node through a downlink control information (DCI) or a network signaling.

According to an implementation of the present disclosure, another DL-RS (expressed by second DL-RS hereinafter) may be configured for the demodulation of the DL channel (e.g., the PDSCH or the PDCCH) by the network node. The second DL-RS may be a DMRS. In an example, the apparatus may receive the second DL-RS along with the DL channel (e.g., the PDSCH or the PDCCH) through at least one second antenna port for the demodulation of the DL channel (e.g., the PDSCH or the PDCCH).

According to an implementation of the present disclosure, in an event that the DL-RS is used for the demodulation, the second DL-RS with at least one second antenna port along with the DL channel for the demodulation may not be received from the network node.

According to an implementation of the present disclosure, in an event that the first antenna port or first antenna pots corresponding to the DL-RS is or are used as the antenna port or antenna ports for the demodulation of DL channel (e.g., the PDSCH or the PDCCH), all or a subset of the second antenna port or second antenna ports corresponding to the second DL-RS may not be received or used. That is, in an event that the DL-RS is used for the synchronization and the demodulation, for the demodulation of the PDSCH or the PDCCH, the apparatus may receive the DL-RS through the first antenna port or first antenna ports corresponding to the DL-RS and receive the second DL-RS through a subset of the second antenna port or second antenna ports corresponding to the second DL-RS. For example, in an event that one first antenna port (e.g., antenna port #1) is applied to the DL-RS, four second antenna ports (e.g., antennal port #1, antennal pot #2, antenna port #3, and antenna port #4) are applied to the second DL-RS, and the demodulation of the PDSCH or the PDCCH needs four antenna ports, the apparatus may receive the DL-RS through the first antenna port (e.g., antennal port #1) corresponding to the DL-RS, and also receive the second DL-RS through the last three second antenna pots (e.g., antennal pot #2, antenna port #3, and antenna port #4) corresponding to the second DL-RS for the demodulation of the DL channel (e.g., PDSCH or the PDCCH).

According to an implementation of the present disclosure, in an event that the DL-RS is used for the synchronization and the demodulation, the second DL-RS for the demodulation of DL channel (e.g., the PDSCH or the PDCCH) may be received on the same symbol as the DL-RS. That is, the second DL-RS may be received based on the transmission pattern of the DL-RS, i.e., the transmission pattern corresponding to the DL-RS, and the second DL-RS may be aligned.

According to an implementation of the present disclosure, in an event that the DL-RS is not used for the demodulation of the DL channel (e.g., the PDSCH or the PDCCH), the DL-RS may be declared/determined as not available for the DL channel (e.g., the PDSCH or the PDCCH). The DL-RS should be rate-matched.

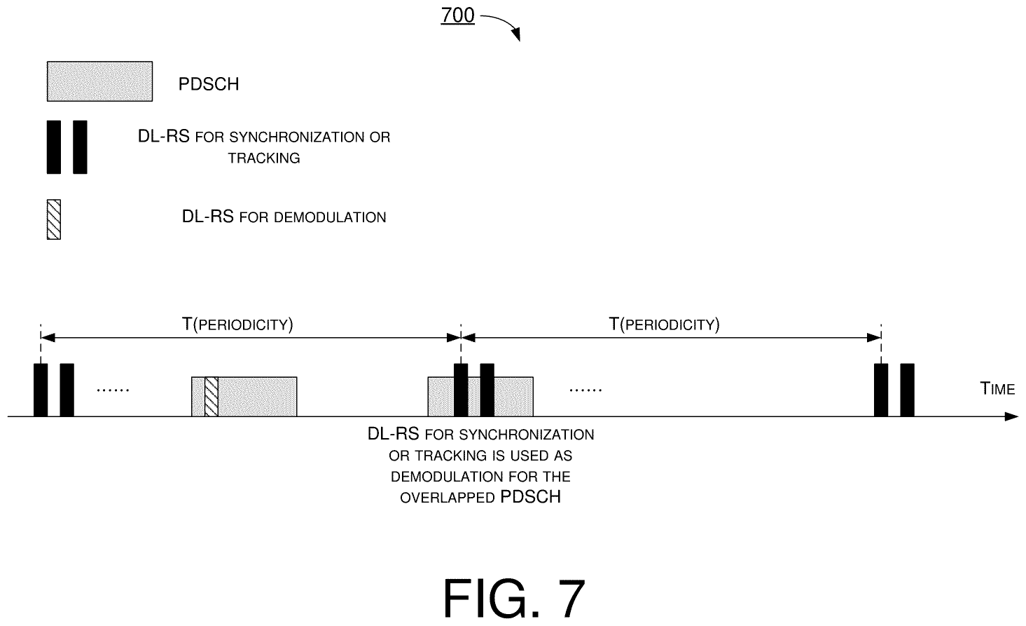

FIG. 7 illustrates an example scenario 700 for another DL-RS for demodulation in accordance with implementations of the present disclosure. Scenario 700 involves a UE and a network node (e.g., a (macro/micro) base station) of a serving cell which may be a part of a wireless network (e.g., an LTE network, a 5G/NR network, an IoT network or a 6G network. Referring to FIG. 7, in event that the DL-RS for the synchronization or tracking overlaps with the PDSCH in the time domain, the DL-RS for the synchronization or tracking may be used for the demodulation of the PDSCH. In addition, in an event that the DL-RS for the synchronization is used for the demodulation of the PDSCH, the apparatus may not receive the DL-RS for the demodulation of the PDSCH from the network node.

### Illustrative Implementations

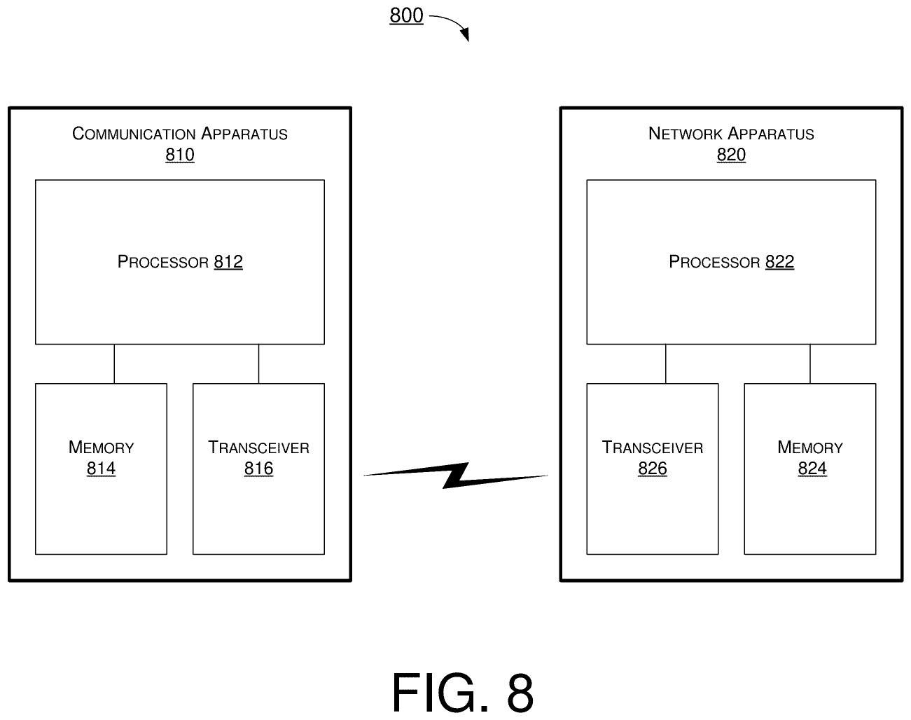

FIG. 8 illustrates an example communication system 800 having at least an example communication apparatus 810 and an example network apparatus 820 in accordance with an implementation of the present disclosure. Each of communication apparatus 810 and network apparatus 820 may perform various functions to implement schemes, techniques, processes and methods described herein pertaining to DL-RS transmission, including the various schemes described above with respect to various proposed designs, concepts, schemes and methods described above and with respect to user equipment and network apparatus in mobile communications, including scenarios/schemes described above as well as process 900 and process 1000 described below.

Communication apparatus 810 may be a part of an electronic apparatus, which may be a UE such as a portable or mobile apparatus, a wearable apparatus, a wireless communication apparatus or a computing apparatus. For instance, communication apparatus 810 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 810 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 810 may be implemented in a smart thermostat, a smart fridge, a smart door lock, a wireless speaker or a home control center. Alternatively, communication apparatus 810 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 810 may include at least some of those components shown in FIG. 8 such as a processor 812, for example.

Communication apparatus 810 may further include one or more other components not pertinent to the proposed schemes of the present disclosure (e.g., internal power supply, display device and/or user interface device), and, thus, such component(s) of communication apparatus 810 are neither shown in FIG. 8 nor described below in the interest of simplicity and brevity.

Network apparatus 820 may be a part of an electronic apparatus, which may be a network node such as a satellite, a BS, a small cell, a router or a gateway of an IoT network. For instance, network apparatus 820 may be implemented in a satellite or an eNB/gNB/TRP in a 4G/5G/B5G/6G, NR, IoT, NB-IoT or IIoT network. Alternatively, network apparatus 820 may be implemented in the form of one or more IC chips such as, for example and without limitation, one or more single-core processors, one or more multi-core processors, or one or more RISC or CISC processors. Network apparatus 820 may include at least some of those components shown in FIG. 8 such as a processor 822, for example. Network apparatus 820 may further include one or more other components not pertinent to the proposed scheme of the present disclosure (e.g., internal power supply, display device and/or user interface device), and, thus, such component(s) of network apparatus 820 are neither shown in FIG. 8 nor described below in the interest of simplicity and brevity.

In one aspect, each of processor 812 and processor 822 may be implemented in the form of one or more single-core processors, one or more multi-core processors, or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed, arranged and configured to perform specific tasks, including DL-RS transmission, in a device (e.g., as represented by communication apparatus 810) and a network node (e.g., as represented by network apparatus 820) in accordance with various implementations of the present disclosure.

In some implementations, communication apparatus 810 may also include a transceiver 816 coupled to processor 812 and capable of wirelessly transmitting and receiving data. In some implementations, transceiver 816 may be capable of wirelessly communicating with different types of UEs and/or wireless networks of different radio access technologies (RATs). In some implementations, transceiver 816 may be equipped with a plurality of antenna ports (not shown) such as, for example, four antenna ports. That is, transceiver 816 may be equipped with multiple transmit antennas and multiple receive antennas for multiple-input multiple-output (MIMO) wireless communications. In some implementations, network apparatus 820 may also include a transceiver 826 coupled to processor 822. Transceiver 826 may include a transceiver capable of wirelessly transmitting and receiving data. In some implementations, transceiver 826 may be capable of wirelessly communicating with different types of UEs of different RATs. In some implementations, transceiver 826 may be equipped with a plurality of antenna ports (not shown) such as, for example, four antenna ports. That is, transceiver 826 may be equipped with multiple transmit antennas and multiple receive antennas for MIMO wireless communications.

In some implementations, communication apparatus 810 may further include a memory 814 coupled to processor 812 and capable of being accessed by processor 812 and storing data therein. In some implementations, network apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 810 and network apparatus 820 may be a communication entity capable of communicating with each other using various proposed schemes in accordance with the present disclosure. For illustrative purposes and without limitation, descriptions of capabilities of communication apparatus 810, as a UE, and network apparatus 820, as a network node (e.g., TRP), are provided below with process 900 and process 1000.

### Illustrative Processes

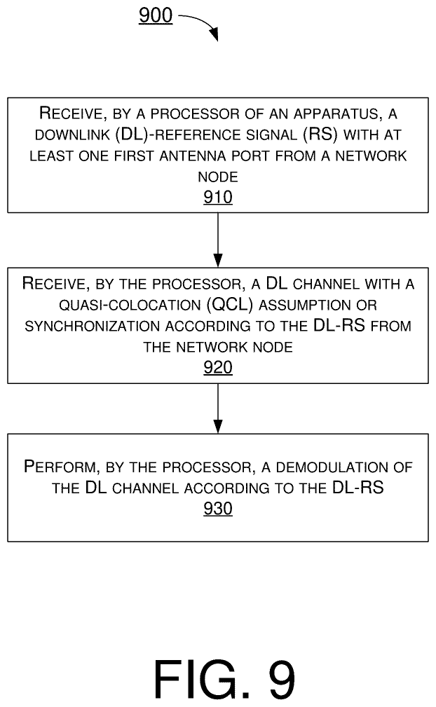

FIG. 9 illustrates an example process 900 in accordance with an implementation of the present disclosure. Process 900 may be an example implementation of above scenarios/schemes, whether partially or completely, with respect to DL-RS transmission with the present disclosure. Process 900 may represent an aspect of implementation of features of communication apparatus 910. Process 900 may include one or more operations, actions, or functions as illustrated by one or more of blocks 910, 920 and 930. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 910. Solely for illustrative purposes and without limitation, process 900 is described below in the context of communication apparatus 910. Process 900 may begin at block 910.

At block 910, process 900 may involve processor 812 of communication apparatus 810 receiving, via transceiver 816, a DL-RS with at least one first antenna port from a network node. Process 900 may proceed from block 910 to block 920.

At block 920, process 900 may involve processor 812 receiving, via transceiver 816, a DL channel with a QCL assumption or synchronization according to the DL-RS from the network node. Process 900 may proceed from block 920 to block 930.

At block 930, process 900 may involve processor 812 performing a demodulation of the DL channel according to the DL-RS.

In some implementations, the DL-RS may be received periodically.

In some implementations, in an event that the DL-RS may be received through more than one first antenna ports, the more than one first antenna ports may be multiplexed in same REs or in different REs.

In some implementations, the DL-RS may be received in at least one symbol or resource.

In some implementations, the DL-RS in each symbol or resource may be received through a same first antenna port or same first antenna ports. The at least one symbol or resource may be received through a same Rx beam or received according to a same QCL assumption.

In some implementations, the DL-RS may comprise an RS resource or an RS resource set.

In some implementations, the DL-RS is used for the demodulation in an event that the DL-RS overlaps with the DL channel.

In some implementations, the DL-RS may overlap with N-th symbol of the DL channel. The N should not larger than a specific value.

In some implementations, the DL channel and the DL-RS may be in a same slot.

In some implementations, the DL-RS may have a bandwidth same as or larger than a bandwidth of the DL channel.

In some implementations, in an event that the DL-RS is used for the demodulation, another DL-RS with at least one second antenna port along with the DL channel for the demodulation may not be received or may be received on a same symbol of the DL-RS.

In some implementations, in an event that the DL-RS is used for the demodulation of the DL channel, at least one another antenna port in additional to the at least one first antenna port may be present and to be used as antennas port or antenna ports for the demodulation of the DL channel.

In some implementations, in an event that the at least one first antenna port corresponding to the DL-RS is used for the demodulation of the DL channel, a subset of at least one second antenna port corresponding to another DL-RS may not be received.

In some implementations, in an event that the DL-RS is not used for the demodulation, the DL-RS may be determined/declared as not available for the DL channel.

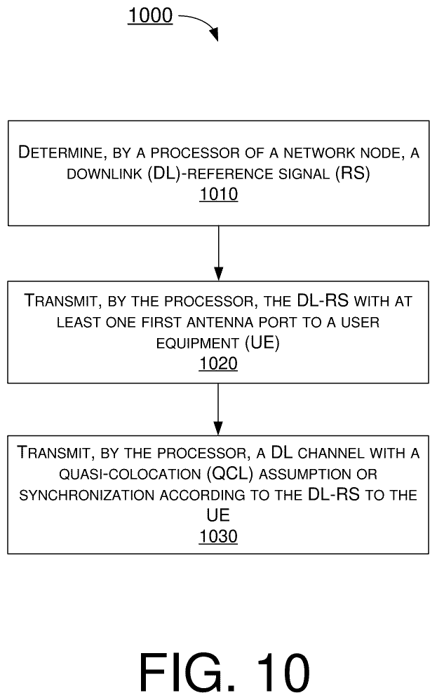

FIG. 10 illustrates an example process 1000 in accordance with another implementation of the present disclosure. Process 1000 may be an example implementation of above scenarios/schemes, whether partially or completely, with respect to DL-RS transmission with the present disclosure. Process 1000 may represent an aspect of implementation of features of network apparatus 820. Process 1000 may include one or more operations, actions, or functions as illustrated by one or more of blocks 1010, 1020 and 1030. Although illustrated as discrete blocks, various blocks of process 1000 may be divided into additional blocks, combined into fewer blocks, or eliminated, depending on the desired implementation. Moreover, the blocks of process 1000 may be executed in the order shown in FIG. 10 or, alternatively, in a different order. Process 1000 may be implemented by network apparatus 820. Solely for illustrative purposes and without limitation, process 1000 is described below in the context of network apparatus 820. Process 1000 may begin at block 1010.

At block 1010, process 1000 may involve processor 822 of network apparatus 820 determining a DL-RS. Process 800 may proceed from block 1010 to block 1020.

At block 1020, process 1000 may involve processor 822 transmitting, via transceiver 826, the DL-RS with at least one first antenna port to a UE. Process 1000 may proceed from block 1020 to block 1030.

At block 1030, process 1000 may involve processor 822 transmitting a DL channel with a QCL assumption or synchronization according to the DL-RS to the UE.

In some implementations, in an event that the DL-RS may be transmitted through more than one first antenna ports, the more than one first antenna ports may be multiplexed in same resource elements (REs) or in different REs.

In some implementations, the DL-RS may be transmitted in at least one symbol or resource. The DL-RS in each symbol or resource may be transmitted through a same first antenna port or same first antenna ports, and wherein the at least one symbol or resource is transmitted through a same Tx beam or transmitted according to a same QCL assumption.

In some implementations, the DL-RS is used for the demodulation of the DL channel in an event that the DL-RS overlaps with the DL channel. The DL-RS may have a bandwidth same as or larger than a bandwidth of the DL channel.

In some implementations, in an event that the DL-RS is used for the synchronization and the demodulation, another DL-RS with at least one second antenna port along with the DL channel for the demodulation may not be transmitted or may be transmitted on a same symbol of the DL-RS.

In some implementations, in an event that the DL-RS is used for the demodulation of the DL channel, at least one another antenna port in additional to the at least one first antenna port may be present and to be used as antennas port or antenna ports for the demodulation of the DL channel.

In some implementations, in an event that the at least one first antenna port corresponding to the DL-RS is used for the demodulation of the DL channel, a subset of at least one second antenna port corresponding to another DL-RS may not be transmitted.

In some implementations, in an event that the DL-RS is not used for the demodulation, the DL-RS may be determined/declared as not available for the DL channel.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink (DL)-reference signal (RS) with at least one first antenna port from a network node;
receiving, by the processor, a DL channel with a quasi-colocation (QCL) assumption or synchronization according to the DL-RS from the network node; and
performing, by the processor, a demodulation of the DL channel according to the DL-RS.

2. The method of claim 1, wherein the DL-RS is received periodically.

3. The method of claim 1, wherein in an event that the DL-RS is received through more than one first antenna ports, the more than one first antennae ports are multiplexed in same resource elements (REs) or in different REs.

4. The method of claim 1, wherein the DL-RS is received in at least one symbol or resource.

5. The method of claim 4, wherein the DL-RS in each symbol or resource is received through a same first antenna port or same first antenna ports, and wherein the at least one symbol or resource is received through a same reception (Rx) beam or received according to the QCL assumption.

6. The method of claim 1, wherein the DL-RS comprises an RS resource or an RS resource set.

7. The method of claim 1, wherein the DL-RS is used for the demodulation of the DL channel in an event that the DL-RS overlaps with the DL channel.

8. The method of claim 1, wherein the DL-RS overlaps with N-th symbol of the DL channel, where the N is not larger than a specific value.

9. The method of claim 1, wherein the DL channel and the DL-RS are in a same slot.

10. The method of claim 1, wherein the DL-RS has a bandwidth same as or larger than a bandwidth of the DL channel.

11. The method of claim 1, wherein in an event that the DL-RS is used for the demodulation, another DL-RS with at least one second antenna port along with the DL channel for the demodulation is not received or is received on a same symbol of the DL-RS.

12. The method of claim 1, wherein in an event that the DL-RS is used for the demodulation of the DL channel, at least one another antenna port in additional to the at least one first antenna port is present and to be used as antennas port or antenna ports for the demodulation of the DL channel.

13. The method of claim 1, wherein in an event that the at least one first antenna port corresponding to the DL-RS is used for the demodulation of the DL channel, a subset of at least one second antenna port corresponding to another DL-RS is not received.

14. The method of claim 1, wherein in an event that the DL-RS is not used for the demodulation, the DL-RS are determined as not available for the DL channel.

15. A method, comprising:
determining, by a processor of a network node, a downlink (DL)-reference signal (RS);
transmitting, by the processor, the DL-RS with at least one first antenna port to a user equipment (UE); and
transmitting, by the processor, a DL channel with a quasi-colocation (QCL) assumption or synchronization according to the DL-RS to the UE.

16. The method of claim 15, wherein in an event that the DL-RS are transmitted through more than one first antenna ports, the more than one first antenna ports are multiplexed in same resource elements (REs) or in different REs.

17. The method of claim 15, wherein the DL-RS is transmitted in at least one symbol or resource, wherein the DL-RS in each symbol or resource is transmitted through a same first antenna port or same first antenna ports, and wherein the at least one symbol or resource is transmitted through a same transmission (Tx) beam or transmitted according to the QCL assumption.

18. The method of claim 15, wherein the DL-RS is used for the demodulation of the DL channel in an event that the DL-RS overlaps with the DL channel, and wherein the DL-RS has a bandwidth same as or larger than a bandwidth of the DL channel.

19. The method of claim 15, wherein in an event that the DL-RS is used for the demodulation, another DL-RS with at least one second antenna port along with the DL channel for the demodulation is not transmitted or is transmitted on a same symbol of the DL-RS.

20. The method of claim 15, wherein in an event that the DL-RS is used for the demodulation of the DL channel, at least one another antenna port in additional to the at least one first antenna port is present and to be used as antennas port or antenna ports for the demodulation of the DL channel; or
in an event that the at least one first antenna port corresponding to the DL-RS is used for the demodulation of the DL channel, a subset of at least one second antenna port corresponding to another DL-RS is not transmitted; or
in an event that the DL-RS is not used for the demodulation, the DL-RS are determined as not available for the DL channel.
